(19) United States
(12) Patent Application Publication
(10) Pub. No.: US 2008/0227438 A1
(43) Pub. Date: Sep. 18, 2008

(54) CONFERENCING USING PUBLISH/SUBSCRIBE COMMUNICATIONS

(75) Inventor: Benjamin Joseph Fletcher, West Yorkshire (GB)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/047,506

(22) Filed: Mar. 13, 2008

(30) Foreign Application Priority Data
Mar. 15, 2007 (GB) 07104239.4

(51) Int. Cl. H04M 3/56

(52) U.S. Cl. 455/416

(57) ABSTRACT

A method and system are for conferencing by exchanging conference communications between two or more participants includes publishing a conference communication to a message broker and subscribing to conference communications at a message broker. A subscription topic specifies one or more type or source of the communication. A conference communication may be one of a text input, transcribed text, audio input, synthesized audio speech, or video input including real or animated images. The method and system of conferencing using publish/subscribe communications allows participants with different communication needs to be accommodated in a flexible manner.

### FIELD OF THE INVENTION

This invention relates to the field of conferencing. In particular, it relates to conferencing using publish/subscribe communications.

### BACKGROUND

Conferencing is used in many business applications to enable people to collaborate, share ideas, discuss projects, obtain advice, etc. Conferencing may be in person, by telephone, by video, by web conferencing, by instant messaging, or by a combination of such methods. Participants may be in a conference location or may be spread remotely. Participants may wish to use different communications methods and systems and may have different communication needs. For example, a participant of a conference who has impaired hearing may find it difficult to follow a flow of input from the other participants.

An example scenario is envisaged including four participants, A, B, C, and D, illustrating diverse forms of communication and communication needs.

Participant A is hearing-impaired and cannot lip-read. B is also hearing-impaired but can lip-read. However, B can only follow one person speaking at a time. The problem is that in conferences, such as brainstorming meetings, very often two or more people speak at the same time. B also needs very good visual skills to determine who is talking at a given time and who is about to talk.

C is a user who has dialed into the conference and is participating by telephone. The problem here is that the sounds received by telephone are not two dimensional but are one dimensional. C cannot follow if two people from different sides of the room are talking at the same time.

D is a user who is participating in the conference using instant messaging (IM). The problem here is that the participants are speaking and are not typing into the IM application, or are only inputting brief summaries of what is being said.

A “one at a time” policy may be employed in a conference; however, such policies often fail once a conference gets underway.

Automatic Speech Recognition (ASR) applications are known which convert voice input into text output. A single ASR application in a meeting could be used to aid the hearing-impaired and, also, to convert voice to text for IM participants. However, in a conference with several people talking, sometimes simultaneously, with different voices and accents, this is not practical.

U.S. Pat. No. 6,618,704 discloses a system for real time teleconferencing where one of the participants is hearing-impaired. Each participant has an ASR system and a chat service system such as an IM application. In the disclosure, a participant's voice is converted into transcribed text which is translated into a chat transmission format. An integration server receives all the participants' chat messages which have various formats and translates them into the format used by the chat service system of the hearing-impaired participant. This enables different chat systems to be supported.

### SUMMARY

According to a first aspect of the present invention there is provided a method for conferencing by exchanging conference communications between two or more participants, comprising: publishing a conference communication to a message broker; and subscribing to conference communications at a message broker, wherein a subscription topic specifies one or more type or source of the communication.

A conference communication may be a text input, transcribed text, audio input, synthesized audio speech, or video input. Audio or video communications may use media streaming with packets published to a message broker.

The method may include: receiving a voice input; converting the voice input to transcribed text; publishing the transcribed text as a conference communication.

The method may also include: receiving a conference communication by a subscription, wherein the communication is in the form of text; converting the text to a synthesized voice; and broadcasting the synthesized voice. Converting the text to a synthesized voice may convert the text to a type of synthesized voice determined by the source of the communication, and different sources may be converted to different types of synthesized voice.

The method may include: receiving a conference communication by a subscription; processing the conference communication; and publishing the processed conference communication to a message broker. The processing may be, for example, translating the communication into another language or another form or type of communication.

Publishing a conference communication may publish a communication from another form of communication system; for example, the communication system may be an instant messaging system or a telephone system.

The method may include publishing an alert to indicate a contributing participant. The method may further include subscribing to the alert and displaying an indication of the location of the contributing participant.

Reference material relating to the conference may be published to a message broker, and a participant may subscribe to the reference material. The reference material may be static in the form of, for example, a file, document, image, audio or video recording, or the reference material may be dynamic in the form of, for example, regular information updates, internet feeds, tracking information.

According to a second aspect of the present invention there is provided a system for conferencing, comprising: at least one participant system including: a publisher application for publishing a conference communication; a message broker; at least one participant system including: a subscriber application for subscribing to conference communications at the message broker, wherein a subscription topic specifies one or more type or source of the communication.

A participant system may include: a voice recognition system for converting a participant's voice communication to transcribed text for publishing as a conference communication.

The system may further comprise: at least one automated module including a publisher application or a subscriber application. A module may include a voice synthesizer for converting published text to synthesized voice.

The system may include a display means for displaying an indication of the location of a source of a conference communication.

According to a third aspect of the present invention there is provided a computer program product stored on a computer readable storage medium, comprising computer readable program code means for performing the steps of: publishing a conference communication to a message broker; and subscribing to conference communications at a message broker, wherein a subscription topic specifies one or more type or source of the communication.

The described method and system enables participants in a conference to talk independently and all other participants are able to follow the dynamics of the conversation irrespective of how they are communicating, for example, by instant messaging, telephone conference, visually or audibly impaired, etc.

### BRIEF DESCRIPTION OF THE DRAWINGS

Embodiments of the present invention will now be described, by way of examples only, with reference to the accompanying drawings in which:

FIG. 1 is a schematic diagram of an example conferencing scenario;

FIG. 2 is a block diagram of a system in accordance with the present invention; and

FIG. 3 is a block diagram of a computer system in which the present invention may be implemented; and

FIG. 4 is a flow diagram of a method in accordance with the present invention.

### DETAILED DESCRIPTION

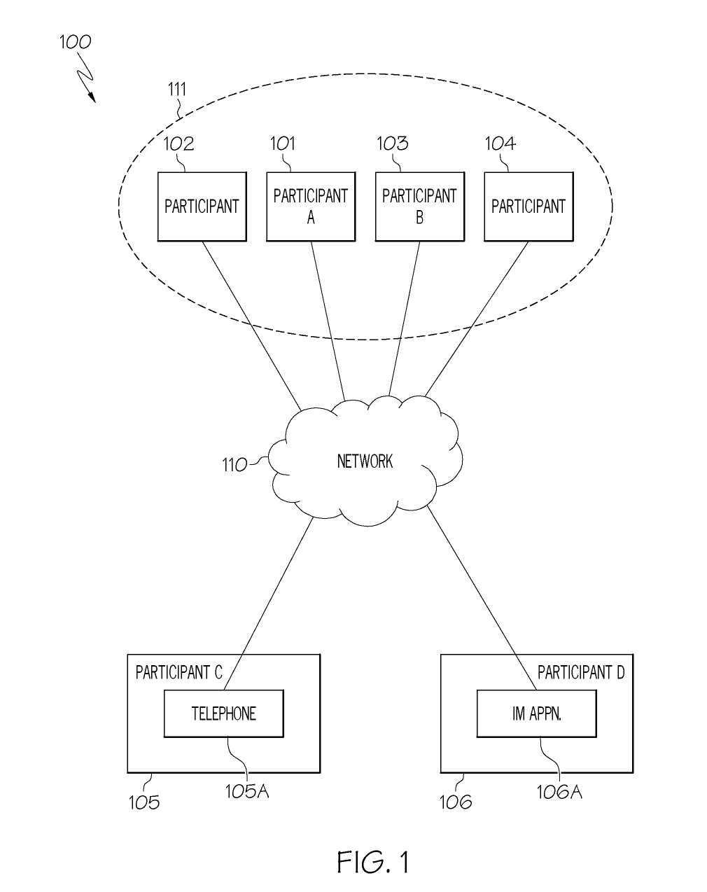

Referring to FIG. 1, an example conference scenario 100 is illustrated in which multiple participants 101-104 are at a given location 111 meeting in person. At least one of the participants (A, B) 101-104 may have impaired hearing.

Another participant (C) 105 is contributing input to the conference and listening to the participants 101-104 by telephone 105a. A further participant (D) 106 is connected to the conference via an IM application 106a.

A communications network 110 which may take the form of a telephone and/or computer network connects the participants 105, 106 who are not at the conference location 111 to the other participants 101-104.

In order to meet the needs of different participants as exemplified by the scenario of FIG. 1, a method and system are described which uses publish/subscribe communications to allow heterogeneous coupling of the participants.

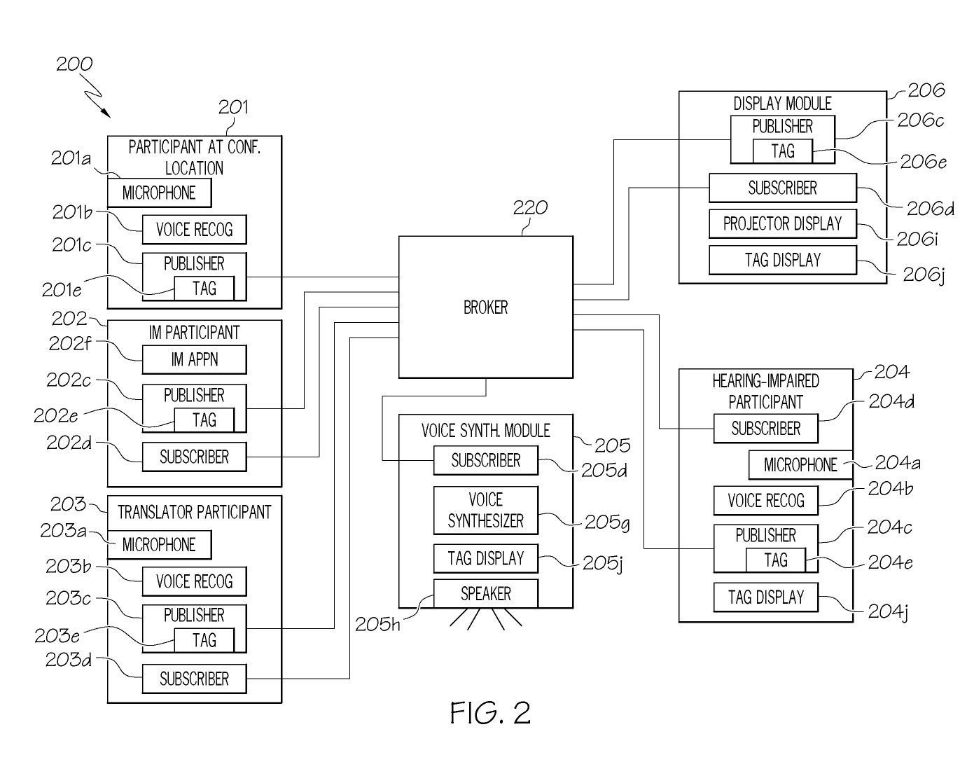

Referring to FIG. 2, a conference system 200 is provided in which each entity 201-206, which includes human participants 201-204 and other system modules 205-206, publish and/or subscribe messages to a broker 220 in order to input and receive the conference communications. Publish/subscribe communications work with a wide range of devices and applications, for example, telephones, PDA's, pagers, projectors, headphones, hearing aids, etc. any of which may be included as entities in the conference.

Publish/subscribe is an asynchronous messaging paradigm. In a publish/subscribe system, publishers post messages to an intermediary broker 220 and subscribers register subscriptions with that broker 220. In a topic-based system, messages are published to “topics” or named logical channels which are hosted by the broker 220. Subscribers in a topic-based system will receive all messages published to the topics to which they subscribe and all subscribers to a topic will receive the same messages. In a content-based system, messages are only delivered to a subscriber if the attributes or content of those messages match constraints defined by one or more of the subscriber's subscriptions.

The messages published by and subscribed to by the entities 201-206 may take the form of different types of communication. The communications may include input text, transcribed text, input audio, voice synthesized audio, video, etc. The communications are made in real time as a participant 201-204 or module 205-206 makes a contribution to the conference. The audio and video communications may use media streaming with packets being published for the publish/subscribe network.

In addition to the conference communications, dynamic or static media may also be communicated via the publish/subscribe network. For example, a participant 201-204 may wish to reference images, stored documents, etc. or a module 205-206 may publish stock market news dynamically during the conference for reference by the participants 201-204.

A conference can be identified in the publish/subscribe communication by means of the topic naming scheme which is a hierarchy. For example, topics could be named as: “companyA/conference6/John Smith/audio”, “companyA/conference6/John Smith/text”, “companyA/conference6/Jane Brown/audio”, etc. There are different ways to select and subscribe the topics an entity 201-206 is interested in. The entity 201-206 can use wildcards to subscribe to all audio topics in Conference 6 by subscribing to the topic “companyA/conference6/#/audio” (note the # denotes “match anything”).

There are a number of options for entities 201-206 who may publish and/or subscribe to different forms of communication from selective other entities 201-206. There are scenarios in which entities 201-206 may only publish or only subscribe to certain publications. For example, a participant 201-204 who does not wish to receive text transcripts of the voice inputs may publish but does not need to subscribe. A participant 204 who is hearing-impaired may subscribe, but may not need to publish if no one else is relying on the text transcripts. A participant 202 who is participating using IM may subscribe, but may send his inputs using the IM application. Alternatively, the IM participant's text inputs may be published, for example, so that the other participants can receive them by their subscription.

The entities 201-206 each have either a publisher application 201c-205c, or a subscriber application 202d-206d, or both. A publisher application 201c-205c may include an alert tag 201e-205e (an “I'm talking” tag) which provides an alert associated with a publication to attract other participants' attention. A topic “companyA/conference6/John Smith/Talking” can have a retained message which is either true or false (e.g. “1” for true, “0” for false). This is a status topic.

Entities 201-206 may have a tag display means 204j-206j, in the form of a device or user interface display on a subscriber application 201-205d, which may be provided with individual display lights or indicators, one for each speaker. A display light illuminates when a flag is received from the tag alert to indicate who is talking. The light may illuminate in the direction of whoever is talking. This may take the form of a seating map or compass to point to the active participant.

FIG. 2 shows a conference system in which different forms of entity 201-206 are illustrated to show the diverse and flexible nature of the publish/subscribe communications applied in a conference scenario.

A first participant 201 is at the conference location and is making his contribution by speaking. The first participant's system 201 has a microphone 201a for inputting his audio speech and a voice recognition system 201b for converting the audio input to text. The participant 201 speaks into his personal microphone 201a and the voice input is either stored as an audio file or converted by the personal voice recognition system 201b to transcribed text. The personal voice recognition system 201b is preferably trained to the participant's voice.

There are many known ASR (Automatic Speech Recognition) processes which may be used in the personal voice recognition systems 201b, 203b. The ASR process comprises three common components: the acoustic front-end (AFE), which is responsible for analyzing the incoming speech signal, the decoder, which matches the parameterized audio to its acoustic model, and the application or user part, the grammar and the associated pronunciation dictionary. The ASR process therefore takes an audio signal as input and produces a text string representation as output.

An ASR system may have a speaker profile stored for the relevant participant. This system 201 has a publisher application 201c which can publish the participant's audio input using an audio streaming protocol. Additionally, or alternatively, the publisher application 201c can publish the transcribed text from the voice recognition system 201b.

A second participant 202 is participating in the conference using an IM application 202f. This participant inputs text or audio using IM chat capabilities of the IM application. The IM inputs are published by the publisher application 202c. The participant 202 has a subscriber application 202d for subscribing to text or audio publications from the other entities 201-206.

A third participant 203 may be at the conference or remotely located and provides a translation service. The participant 203 has a publisher application 203c and a subscriber application 203d. The participant 203 has a microphone 203a and, optionally, a voice recognition system 203b for converting audio input to text. The participant 203 receives publications as audio or text, translates them into another language and publishes the translation as audio or text. The text may be input by the participant 203 or transcribed from the audio input using the voice recognition system 203b.

The translator participant 203 may provide visual translation into sign language in which case a video recording means would be provided with the publications being in the form of video streaming.

A translation module (not shown) may be provided in a similar way to the translating participant 203 but as an automated system receiving publications as text or audio and using computer translation to translate and re-publish the translated text or audio. If audio publications are used, voice recognition and voice synthesis may be required.

A fourth participant 204 is a hearing-impaired participant who has a subscriber application 204d which subscribes to the broker 220 to receive the transcribed text publications of any audio input from the other participants. The participant 204 can subscribe to participants' “I'm talking” tag to determine who's speech is being received as transcribed text. The participants 201-203 can also gain a hearing-impaired participant's attention, if he is looking away, by publishing to the “I'm talking” topic. The hearing-impaired participant 204 has a tag display 204j to show the direction of the contributing participant 201-203 or module 205-206.

A first example module 205 in the system 200 is a voice synthesizer module 205 with a subscriber application 205d, a voice synthesizer 205g for converted received text to speech output, and a speaker 205h for broadcasting the speech output.

Voice synthesizers 205g (or text-to-speech (TTS) synthesizers) are well know in the art. Synthesized speech can be created by concatenating pieces of recorded speech that are stored in a database. Systems differ in the size of the stored speech units; a system that stores phones or diphones provides the largest output range, but may lack clarity. For specific usage domains, the storage of entire words or sentences allows for high-quality output. Alternatively, a synthesizer can incorporate a model of the vocal tract and other human voice characteristics to create a completely “synthetic” voice output.

The voice synthesizer module 205 may be used at the meeting location to convert published text from participants who are only contributing by text into voice output. This is useful if some of the participants are not subscribing to text transcripts or do not wish to look at IM contributions, for example if they are visually-impaired. They can listen to any text inputs as synthesized voice. The identification of the participants in the topic associated with the published text can be used to switch to an appropriate synthesized voice profile for each participant. For example, a male voice, a female voice, a regional accent, etc. The voice synthesizer module 205 includes a tag display 205j to show the location of the voice synthesized contributor.

Another example module 206 in the system 200 is a display module 206 with a subscriber application 206d, and a display mechanism 206i (for example, a projector) for displaying text received by the subscriber application 206d. For example, the subscriber application 206d may subscribe to publications from a chairperson of the conference who publishes summary points or headers of an agenda at time intervals during the conference. The display module 206 may also include a publisher application 206c for publishing dynamic data inputs such as stock market updates from another information source. The display module 206 may include a tag display 206j.

The many-to-one nature of publish/subscribe means that the published transcribed texts turn from two dimensional speech into one dimensional text and a user contributing by telephone can follow the meeting more clearly by reading the tagged text.

In addition to the above described uses, the system may also be used to provide a transcript of the conference by subscribing to all the published texts relating to the meeting with the identification tags. A transcript of each contribution as published can be kept as a record of the conference. This would require that all participants 201-204 publish their input as transcribed text.

The entities 201-206 work simultaneously and the publish/subscribe paradigm allows many-to-one, so multiple publications can be received and processed by the broker 220 simultaneously. The use of publish/subscribe technology allows the entities to select which participants' publications or which form of publications (such as text/audio/alerts) they want to receive.

The publish/subscribe messaging infrastructure can ensure that publications are provided in the order they are published. Subscribers receive the publications in the order they are published. This provides a chorological order for subscriptions showing a flow through the conference. Alternatively, publications can be time-stamped. This can be done by the broker 220, or by a publish/subscribe application which adds time-stamps to publications.

Some examples of different requirements which can be met and the flexibility provided by the described system are as follows. A user can elect to receive only “I'm talking” alerts from people to their right because they have poor hearing, or sight, to their right. A user can elect to receive text from people in front, for transcript purposes, and audio from people further away in the conference room, because they are too far for the user to lip-read or hear. Participants might want to receive text from participants not in the room, because they can not be lip-read, whereas audio is fine for people in the room, because they can be lip-read.

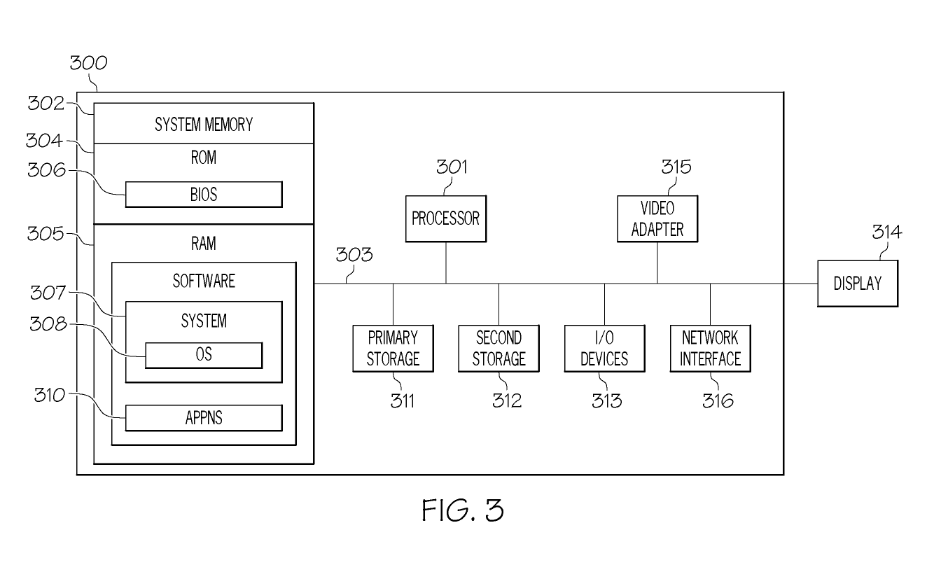

Referring to FIG. 3, an exemplary system for implementing the described participant systems or modules includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

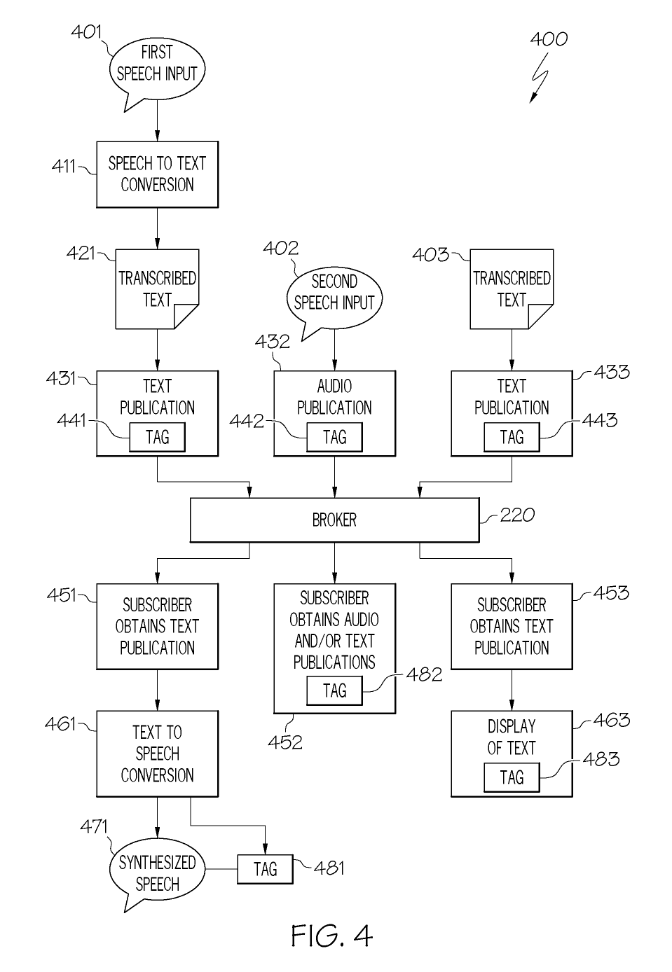

Referring to FIG. 4 a schematic flow diagram 400 shows examples of the processes of the described method.

A participant provides a first speech input 401. Concurrently or subsequently, another participant provides a second speech input 402. Another participant is communicating by IM and provides a text input 403.

The first speech input 401 is converted 411 to transcribed text 421. The transcribed text 421 is published 431 to a message broker together with a tag alert 441 indicating the source of the publication 431.

The second speech input 402 is published 432 as an audio stream. An alert tag 442 is provided indicating the source of the publication 432.

The text input 403 is published 433 as a text publication together with a tag alert 443 indicating the source of the publication 433.

A subscriber obtains 451, 452, 453 selected ones of the publications 431, 432, 433 depending on the subscribed topic.

A first subscriber may obtain 451 text publications and convert 461 them to synthesized speech 471. The synthesized speech 471 may have an associated display of the tag 481 indicating the source of the speech 471. The subscriber may only convert 463 to synthesized speech 473 the text publications 433 which did not originate as speech, for example IM text inputs.

A second subscriber may obtain 452 text and audio publications with the associated tag alert 482 for the subscribers use.

A third subscriber may obtain 453 text publications and display 463 the text with the associated tag 483 of the source.

A subscriber may process the publications, for example, by translating into another language, and re-publish them for use by other participants.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

What is claimed is:

1. A method for conferencing by exchanging conference communications between two or more participants, comprising:
publishing a conference communication to a message broker; and
subscribing to conference communications at a message broker, wherein a subscription topic specifies one or more type or source of the communication.

2. A method as claimed in claim 1, wherein a conference communication is one of a text input, transcribed text, audio input, synthesized audio speech, or video input.

3. A method as claimed in claim 2, wherein audio or video communications use media streaming with packets published to a message broker.

4. A method as claimed in claim 1, including:
receiving a voice input;
converting the voice input to transcribed text; and
publishing the transcribed text as a conference communication.

5. A method as claimed in claim 1, including:
receiving a conference communication by a subscription, wherein the communication is in the form of text;
converting the text to a synthesized voice; and
broadcasting the synthesized voice.

6. A method as claimed in claim 5, wherein converting the text to a synthesized voice, converts the text to a type of synthesized voice determined by the source of the communication, and wherein different sources are converted to different types of synthesized voice.

7. A method as claimed in claim 1, including:
receiving a conference communication by a subscription;
processing the conference communication; and
publishing the processed conference communication to a message broker.

8. A method as claimed in claim 7, wherein the processing is translating the communication into another language or another form or type of communication.

9. A method as claimed in claim 1, wherein publishing a conference communication publishes a communication from another form of communication system.

10. A method as claimed in claim 9, wherein the communication system is an instant messaging system or a telephone system.

11. A method as claimed in claim 1, including publishing an alert to indicate a contributing participant.

12. A method as claimed in claim 11, including subscribing to the alert and displaying an indication of the location of the contributing participant.

13. A method as claimed in claim 1, including publishing reference material to a message broker, and subscribing to the reference material at a message broker.

14. A method as claimed in claim 13, wherein the reference material is static in the form of one of a file, document, image, audio or video recording, or the reference material is dynamic in the form of one of regular information updates, internet feeds, tracking information.

15. A system for conferencing, comprising:
at least one participant system including:
a publisher application for publishing a conference communication;
a message broker; and
at least one participant system including:
a subscriber application for subscribing to conference communications at the message broker, wherein a subscription topic specifies one or more type or source of the communication.

16. A system as claimed in claim 15, wherein a participant system includes:
a voice recognition system for converting a participant's voice communication to transcribed text for publishing as a conference communication.

17. A system as claimed in claim 15, further comprising:
at least one automated module including a publisher application or a subscriber application.

18. A system as claimed in claim 17, wherein a module includes a voice synthesizer for converting published text to synthesized voice.

19. A system as claimed in claim 15, including a display means for displaying an indication of the location of a source of a conference communication.

20. A computer program product stored on a computer readable storage medium, comprising computer readable program code means for performing the steps of:
publishing a conference communication to a message broker; and
subscribing to conference communications at a message broker, wherein a subscription topic specifies one or more type or source of the communication.
